(19) United States
(12) Patent Application Publication
(10) Pub. No.: US 2022/0105369 A1
(43) Pub. Date: Apr. 7, 2022

(54) ADJUSTABLE FACEMASK

(71) Applicant: Kristine Erive Lee, Seattle, WA (US)

(72) Inventor: Kristine Erive Lee, Seattle, WA (US)

(21) Appl. No.: 17/495,471

(22) Filed: Oct. 6, 2021

Related U.S. Application Data
(60) Provisional application No. 63/088,161, filed on Oct. 6, 2020.

(51) Int. Cl. A62B 18/08; A62B 23/02; A41D 13/11

(52) U.S. Cl. CPC A62B 18/084; A41D 13/1161; A62B 23/02

(57) ABSTRACT

Embodiments of a device for a facial protection device includes a facial covering portion, a first strap, and a second strap. The facial covering portion includes a fabric material which forms a first sleeve and a second sleeve. The first strap passes through the first sleeve. The first strap includes a first strap portion extending from a first side of the facial covering portion and a second strap portion extending from a second side opposite the first side of the facial covering. The first strap portion is adjustably attached to the second strap portion. The second strap passes through the second sleeve. The second strap includes a third strap portion extending from the first side of the facial covering portion and adjustably attached to the first strap portion and a fourth strap portion extending from the second side of the facial covering and adjustably attached to the second strap portion.

### CROSS REFERENCE TO RELATED APPLICATIONS

This application claims priority to Provisional Patent Application No. 63/088,161, which was filed Oct. 6, 2020, which is incorporated in its entirety.

### FIELD OF THE DISCLOSURE

The present invention relates to devices for face coverings.

### BACKGROUND

In many situations it is desirable to use a facemask or other facial protections. These situations include times when a wearer might be exposed to airborne pathogens, contaminants, or particulates.

Most forms of facial protection require the facial covering to be completely supported by the ears when in use. This often results in the facial protection becoming an irritant or inducing pain onto the ears. Accordingly, most existing forms of facial protection are inconvenient for the wearer and often end up either not being used or being difficult to sustain prolonged usage in situations when the facial covering is needed.

### SUMMARY

One or more embodiments are provided below for a facial protection device. The facial protection device may include a facial covering portion, a first strap, and a second strap. The facial covering portion may include a fabric material which forms a first sleeve and a second sleeve. The first strap may pass through the first sleeve. The first strap may have a first length. The first strap may include a first strap portion extending from a first side of the facial covering portion and a second strap portion extending from a second side opposite the first side of the facial covering. The first strap portion may be adjustably attached to the second strap portion. The second strap may pass through the second sleeve. The second strap may have a second length shorter than the first length. The second strap may include a third strap portion extending from the first side of the facial covering portion and a fourth strap portion extending from the second side of the facial covering. The third strap portion may be adjustably attached to the first strap portion. The fourth strap portion may be adjustably attached to the second strap portion.

The facial protection device may provide significant advantages over the facial protection devices known in the art. The facial protection device may be significantly more comfortable and more easily adjustable than other facial coverings. The facial protection device allows for the size of the head of the wearer to be adjusted for by adjusting the connector between the first strap portion and the second strap portion. Furthermore, the positioning of the connections of the third strap portion to the first strap portion, the second strap portion to the first strap portion, and the fourth strap portion to the second strap portion may be adjusted to maximize comfort of the wearer. The adjustments may be done by hand without removing the mask allowing for more better and quicker adjustments to be made.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an example front view of a facial protection device while upon a wearer's head.

FIG. 2A shows an example right side view of a facial protection device, while upon a wearer's head, detailing a first attachment point located behind an ear of the wearer.

FIG. 2B shows an example right side view of a facial protection device, while upon a wearer's head, detailing a first attachment point located behind an ear of the wearer that has been adjustably moved further towards the back of the wearer's head.

FIG. 3A shows an example left side view of a facial protection device, while upon a wearer's head, detailing a second attachment point located behind an ear of the wearer.

FIG. 3B shows an example left side view of a facial protection device, while upon a wearer's head, detailing a second attachment point located behind an ear of the wearer that has been adjustably moved further towards the back of the wearer's head.

FIG. 4 shows an example back view of a facial covering while upon a wearer's head.

FIG. 5 shows an example standalone front view of the facial protection device.

FIG. 6 shows an example standalone back view of the facial protection device.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

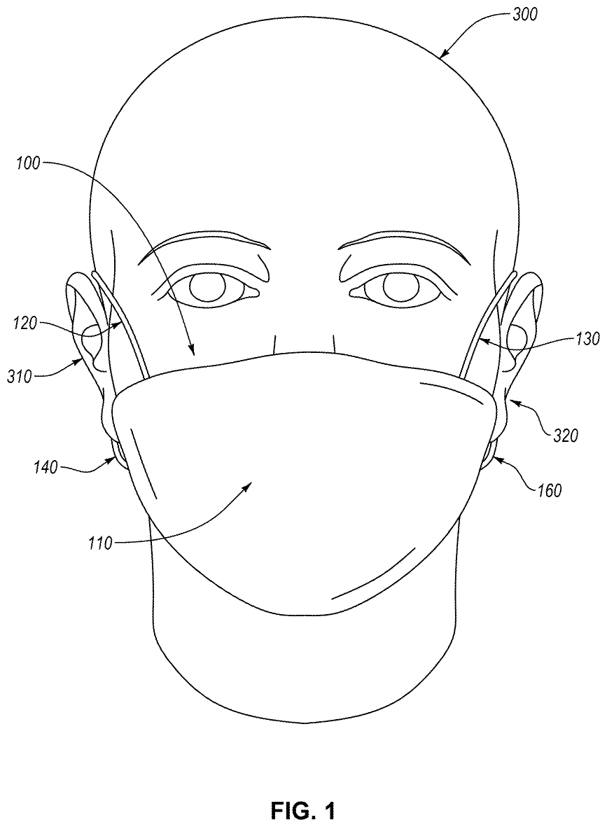

FIG. 1 shows an example front view of a facial protection device 100. The facial protection device 100 may be configured to be worn on a head of a wearer 300 in order to protect the wearer 300 from inhaling airborne contaminants or otherwise contacting contaminants in the area of the mouth and nose. The facial protection device 100 may have a facial covering portion 110 that may cover a wearer's 300 nose, mouth, and chin. A first strap portion 120 may extend from the facial covering portion 110 at a right side of the wearer's 300 head and may rise up and over a right ear 310 of the wearer 300. A second strap portion 130 may similarly extend from the facial covering portion 110 at a left side of the wearer's head and rise up and over the left ear 320. A third strap portion 140 may also extend from the right side of the wearer's 300 head and may go down and under the right ear 310 of the wearer 300 and adjustably connect to the first strap portion 120 behind the right ear 310 of the wearer 300. Additionally, a fourth strap portion 160 may extend from the left side of the wearer's 300 head and may go down and under the left ear 320 of the wearer 300 and adjustably connect to the second strap portion 130 behind the left ear 320 of the wearer 300. The first strap portion 120 and second strap portion 130 may connect behind the head of the wearer 300 to secure the facial protection device 100 in location on the head of the wearer 300.

The first strap portion 120, the second strap portion 130, the third strap portion 140, and the fourth strap portion 160 may be fabric strips, paracord, leather, or any other material suitable for securing the facial covering portion 110 to the head of the wearer 300. The facial covering portion 110 may include fabric, mesh, or other similar materials suitable for covering the nose, mouth, and chin of the wearer 300. The first strap portion 120 and the third strap portion 140 may extend from a first side of the facial protection portion 110. The second strap portion 130 and fourth strap portion 160 may extend from a second side of the face mask opposite the first side.

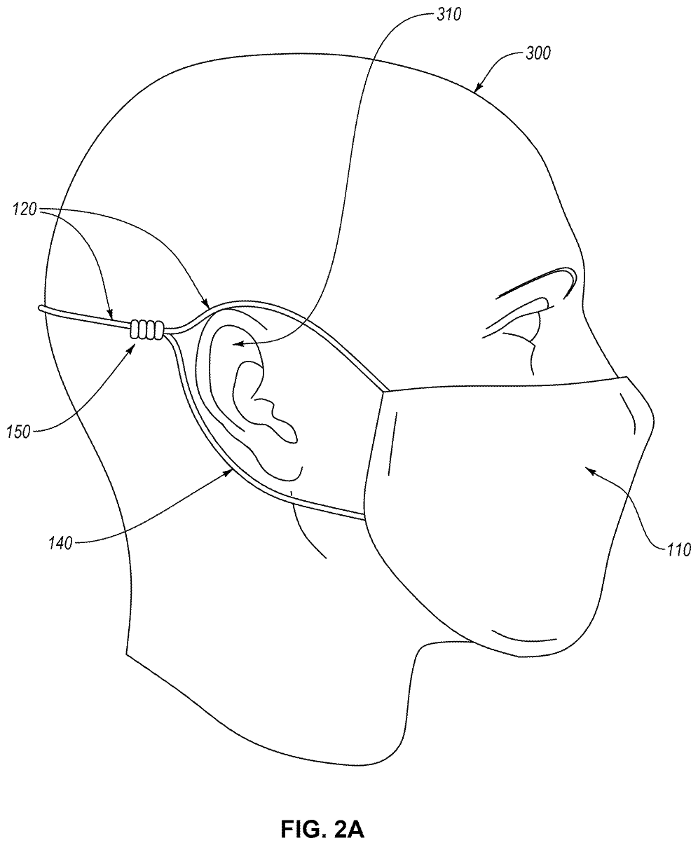

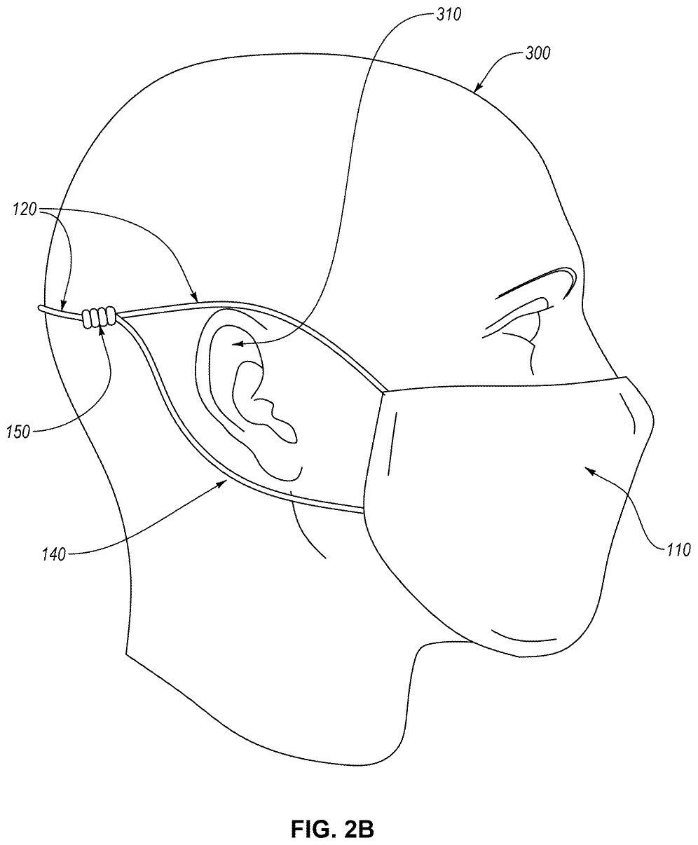

FIG. 2A shows an example right side view of the facial protection device 100, while upon a wearer's 300 head, with the first connector 150 located behind an ear of the wearer 300. The facial covering portion 110 may, from a right side view, cover the nose, mouth, and chin of the wearer 300. The first strap portion 120 may extend from the facial covering portion 110 towards the back of the wearer's 300 head. The third strap portion 140 may connect to the first strap portion 120 via the first connector 150.

The first connector 150 may be a knot in the material of the third strap portion 140, a hook, clamp, clasp, or any other suitable connector. The first connector 150 may be made out of the same material as the first strap portion 120 and third strap portion 140. The first connector 150 may also be made out of other fabric materials, plastics, metals, composites, or any other suitable materials. The first connector may, in a non-limiting embodiment, be a tied knot between the first strap portion 120 and third strap portion 140 that will remain (e.g., does not move) in position during normal use and wear. Upon an applied force, such as manual force applied by a hand of the wearer 300, the first connector 150 may be slidably relocated to a different location on the first strap portion 120. The relocation of the first connector 150 may be to accommodate different ear sizes of different wearers 300, relieve ear pressure by forming a larger loop around the ear, change the tightness of the facial covering portion 110 upon the nose, mouth, and chin of the wearer 300, and aid in the facial protection device's 100 removal.

In a first example, the first connector 150 may be a knot. The knot may be made out of the same material as the first strap portion 120 or any other suitable material. The knot may extend from the third strap portion 140 and connect to the first strap portion 120. The knot may connect to the first strap portion 120 with enough grip to stay (e.g., does not move) in place during normal use and wear. Additionally, the application of force by the hand of the wearer 300 may allow the knot to be repositioned along the second strap portion 120. The repositioning of the knot may confer all of the same, non-limiting benefits as described above.

In a second example, the first connector 150 may be a hook. The hook may be made out of plastic, metal, composites, or any other suitable material. The hook may extend from the third strap portion 140 and connect to the first strap portion 120. The hook may connect to the first strap portion 120 with enough grip to stay in place during normal use and wear. Additionally, the application of force by the hand of the wearer 300 may allow the hook to be repositioned along the first strap portion 120. The repositioning of the hook may confer all of the same, non-limiting benefits as described above.

In a third example, the first connector 150 may be a clamp. The clamp may be made out of plastic, metal, composites, or any other suitable material. The clamp may extend from the third strap portion 140 and connect to the first strap portion 120. The clamp may connect to the first strap portion 120 with enough grip to stay in place during normal use and wear. Additionally, the application of force by the hand of the wearer 300 may allow the clamp to be repositioned along the first strap portion 120. The repositioning of the clamp may confer all of the same, non-limiting benefits as described above.

In a fourth example, the first connector 150 may be a clasp. The clasp may be made out of plastic, metal, composites, or any other suitable material. The clasp may extend from the third strap portion 140 and connect to the first strap portion 120. The clasp may connect to the first strap portion 120 with enough grip to stay in place during normal use and wear. Additionally, the application of force by the hand of the wearer 300 may allow the clasp to be repositioned along the first strap portion 120. The repositioning of the clasp may confer all of the same, non-limiting benefits as described above.

FIG. 2B shows an example right side view of the facial protection device 100, while upon a wearer's 300 head, detailing the first connector 150 located behind an ear of the wearer 300 that has been adjustably moved further towards the back of the wearer's 300 head. The figure shows how the first connector 150 may be adjustably relocated along the first strap portion 120 when a force such as a manual force applied by the hand of the wearer 300 is applied to the first connector 150. Such a manual force may include grasping the connector and sliding it to a different location, unclasping and reclasping the connector, unhooking and re-hooking the connector, untying and retying the connector, and unclamping and re-clamping the connector. Non-manual forces such as wind, tension from moving the head of the wearer 300, and tension from jaw movement during talking may not be capable of moving the first connector 150.

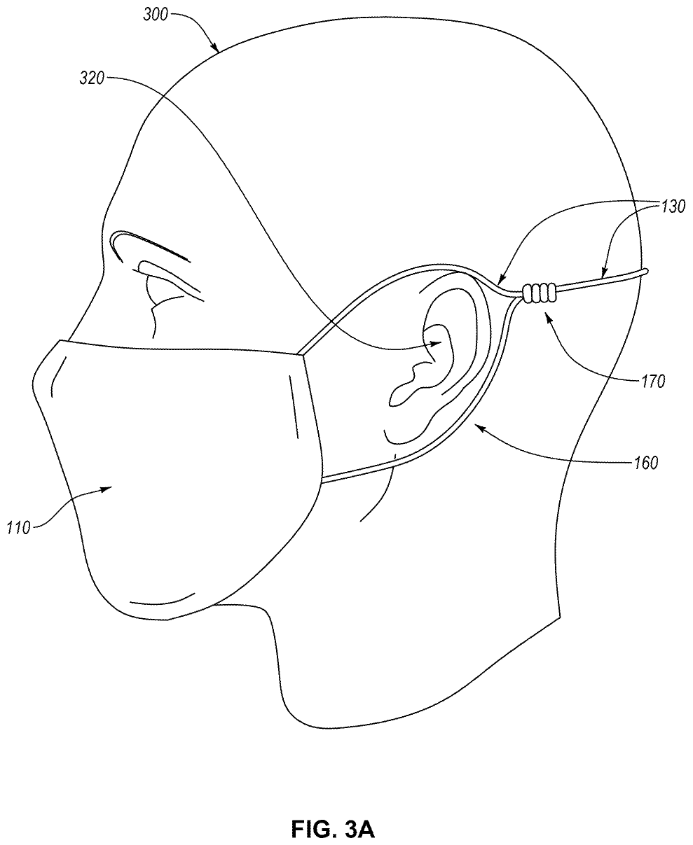

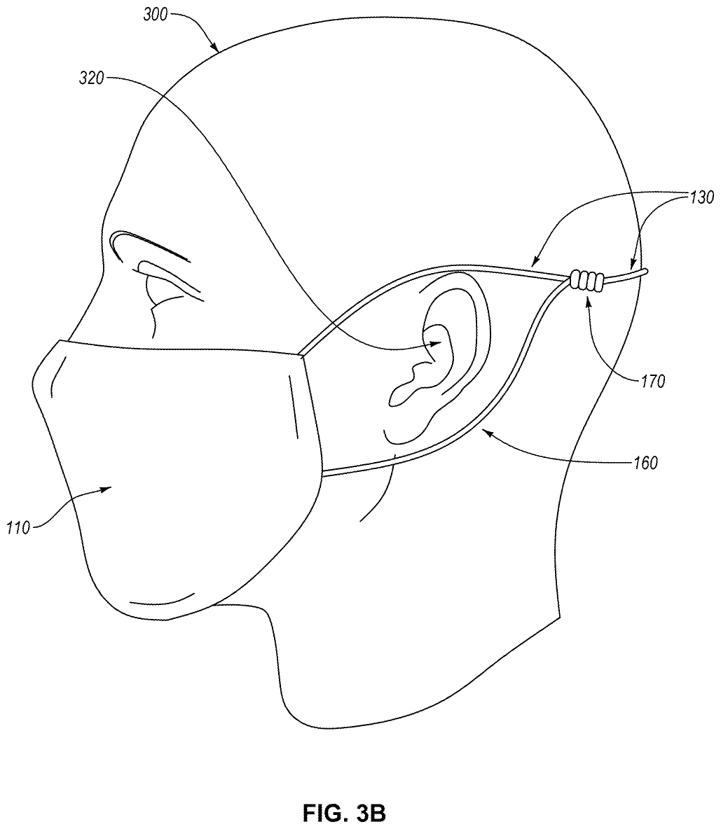

FIG. 3A shows an example left side view of the facial protection device 100, while upon a wearer's 300 head, with the second connector 170 located behind an ear of the wearer 300. The facial covering portion 110 may, from a left side view, cover the nose, mouth, and chin of the wearer 300. The second strap portion 130 may extend from the facial covering portion 110 towards the back of the wearer's 300 head. The fourth strap portion 160 may also extend from the facial covering portion and connect to the second strap portion 130 via the second connector 170.

The second connector 170 may be similar to the first connector 150 in both material and function. The second connector 170 may be made out of the same materials as the first connector 150. The second connector 170 may be secured similarly to the first connector 150 such that the second connector 170 will remain in position during normal use and wear. Upon an applied manual force, the second connector 170 may be slidably relocated to a different location on the second strap portion 130. The relocation of the second connector 170 may be beneficial for the same reasons as the first connector 150 as described above. The second connector 170 may be the same as the first connector 150 in all regards except that the second connector 170 may attach the fourth strap portion 160 to the second strap portion 130.

In four examples, second connector 170 may be one of a knot, a hook, a clamp, or a clasp. The knot may be the same as the knot of the first connector 150. The second connector 170 may also be a hook. The hook may be the same as the hook of the first connector 150. The second connector 170 may also be a clamp. The clamp may be the same as the clamp of the first connector 150. The second connector 170 may, finally, also be a clasp. The clasp may be the same as the clasp of the first connector 150.

FIG. 3B shows an example left side view of the facial protection device 100, while upon a wearer's 300 head, with the second connector 170 located behind an ear of the wearer 300 that has been adjustably moved further towards the back of the wearer's 300 head. The figure shows how the second connector 170 may be adjustably relocated along the second strap portion 130.

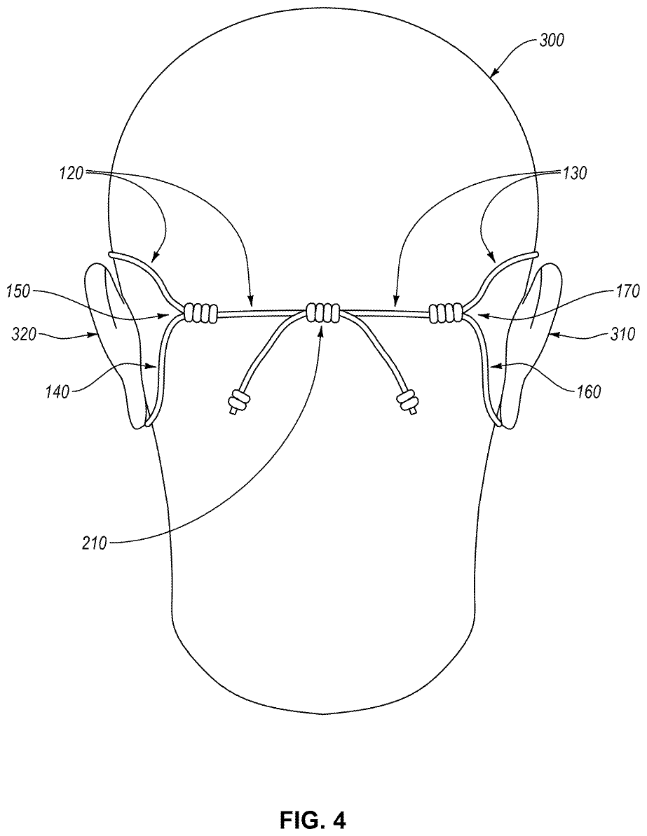

FIG. 4 shows an example back view of the facial protection device 100 while upon a wearer 300's head. The figure details an exemplary configuration of the components of the facial protection device 100 including the first strap portion 120, second strap portion 130, third strap portion 140, fourth strap portion 160, first connector 150, second connector 170, and a rear connector 210 (third connector). The rear connector 210 may comprise the joining of the first strap portion 120 and second strap portion 130 via knots, hooks, clasps, clamps, or other similar devices. The position of the rear connector 210 may be adjusted higher or lower upon the wearer's 300 head by adjusting the first connector 150, the second connector 170, and the rear connector 210. Similarly, in some example embodiments, the facial protection device 100 may hang from a wearer's 300 neck and thus the location of the rear connector 210 may reside upon a back of the wearer's 300 neck. A wearer may adjust the rear connector 210 to be looser on the head of the wearer 300 before removing the facial protection device 100 from the mouth and nose area of the wearer 300 and may adjust the rear connector 210 to be tighter on the head of the wearer 300 after placing the facial protection device 100 on the mouth and nose area of the head of the user.

The rear connector 210 may be formed by the same characteristics as the first connector 150 and second connector 170 as described above. The rear connector 210 may also be used to both tighten and loosen the joining of the first strap portion 120 and the second strap portion 130 when worn on the head of a wearer 300. Additionally, the rear connector 210 may be tightened and loosened in order to increase the wearer's 300 comfort, aid in reducing ear pressure, secure the mask over the wearer's 300 mouth, nose, and chin, allow for wear upon the wearer's 300 neck at times when the wearer 300's mouth and nose need to be uncovered, adjust a seal to the wearer's 300 face around the mouth and nose, and to, generally, increase comfort and the overall filtering effectiveness of the facial protection device 100.

In four examples, the rear connector 210 may be a knot, a hook, a clasp, or a clamp. The knot may be the same as the knot previously described with relation to the first connector 150. The rear connector 210 may also be a hook. The hook may be the same as the hook previously described with relation to the first connector. 150. The rear connector 210 may also be a clamp. The clamp may be the same as the clamp previously described with relation to the first connector 150. The rear connector 210 may also be a clasp. The clasp may be the same as the clasp previously described with relation to the first connector 150.

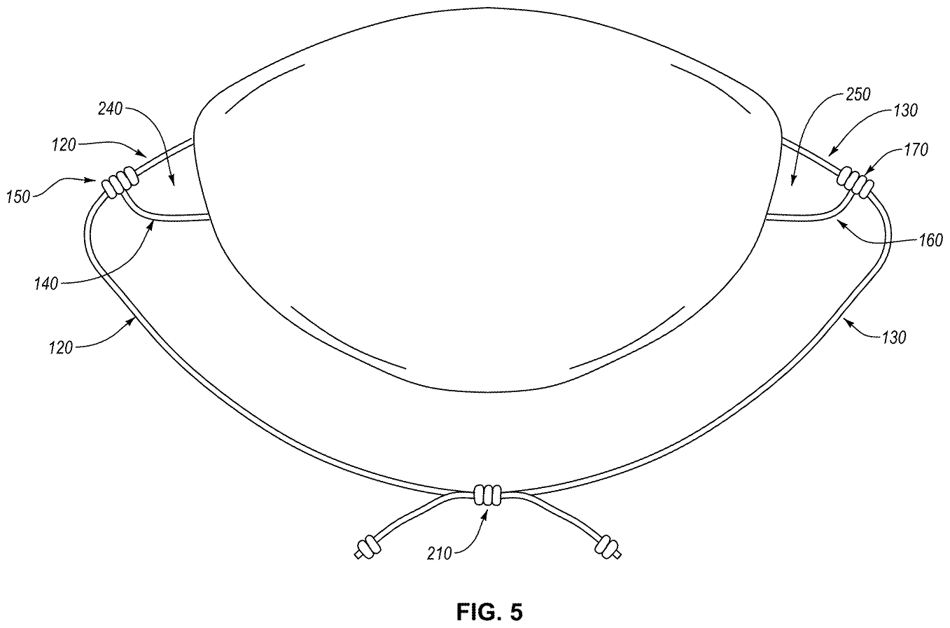

FIG. 5 shows an example standalone front view of the facial protection device 100. The figure is an exemplary view of some of the components that make up the facial protection device 100. The facial covering portion 110 may have a generally oval shape in order to adequately cover the nose, mouth, and chin of a wearer 300. The first connector 150 may be adjustably located at any point along the first strap portion 120. The adjustments of the first connector 150 may cause a right ear loop 240 to either expand or contract. The second connector 170 may be adjustably located similar to that of the first connector 150, except that it may be adjustably moved along the second strap portion 130 and may cause a left ear loop 250 to either expand or contract. The first strap portion 120 may connect or enter into the facial covering portion 110 at a right side and above the location where the third strap portion 140 may connect or enter into the facial covering portion 110. The second strap portion 130 and fourth strap portion 160 may attach or enter into the facial covering portion 110 in a similar fashion as described above with relation to the first strap portion 120 and the third strap portion 140, respectively, except that the second strap portion 130 and the fourth strap portion 160 may enter or connect at an opposite side of the facial covering portion 110. The first strap portion 120 and second strap portion 130 may extend from the facial covering portion 110 and meet each other at the rear connector 210.

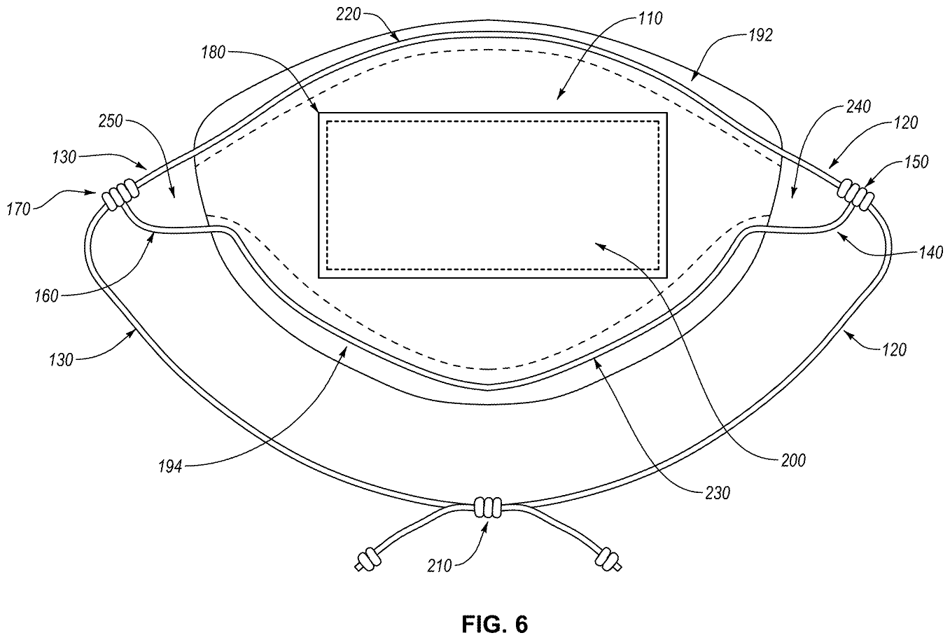

FIG. 6 shows an example standalone back view of the facial protection device 100. A first sleeve 192 and a second sleeve 194 may be formed. The boundaries of the first sleeve 192 are depicted as being between a top edge of the facial covering portion 110 and a dashed line proximate to the top edge of the facial covering portion 110. The boundaries of the second sleeve 194 are depicted between the bottom edge of the facial covering portion 110 and a dashed line proximate to the bottom edge of the facial covering portion 110. The dashed lines may be representative of sewing, adhesives, or any other suitable form of forming the first sleeve 192 and second sleeve 194. The facial covering portion 110 may include a material overlay including meshing, fabric, leather, or any other suitable material. The first strap portion 120 and second strap portion 130 may form a first strap length 220 (first strap) that may pass through within the first sleeve 192 at the top of the back of the facial covering portion 110. Similarly, the third strap portion 130 and fourth strap portion 160 may form a second strap length 230 (second strap) that may pass through the second sleeve 194 at the bottom of the back of the facial covering portion 110. The first sleeve 192 and second sleeve 194 may confer such, non-limiting, benefits as aiding in creating a better facial covering portion 110 seal, decrease any airborne contaminants from passing through, create a more comfortable fit, aid in the adjustability, generally, of the facial protection device 100, and allow for the interchangeability of different facial covering portions 110 that may be of different sizing, more or less filtering capability, different aesthetic design, and temperature retention capability depending on the season.

A pocket 180 may be formed at the back of the facial covering portion 110. The pocket 180 may be formed out of the material overlay by sewing, adhesives, or any other suitable means of forming the pocket 180. The pocket 180 may accommodate a filter 200. The filter 200 may be made out of any material suitable for providing air contaminant filtering such as foam, perforated plastic, cloth, and cardboard. The pocket 180 and filter 200 may, in one or more non-limiting embodiments, be beneficial by providing wearer 300 additional protection from airborne contaminants, prevent the wearer 300 from spreading exhaled bacteria or viruses, and providing temperature insulation to the wearer 300.

Many different embodiments of the inventive concepts have been shown. A person of ordinary skill in the art will appreciate that the features from different embodiments may be combined or replaced with other features from different embodiments.

Advantageously, the device may be significantly more comfortable and more easily adjustable than other facial coverings. The device allows for the size of the head of the wearer to be adjusted for by adjusting the rear connector 210 between the first strap portion 120 and the second strap portion 130. Furthermore, the positioning of the first connector 150 of the third strap portion 140 to the first strap portion 120 and second connector 170 of the fourth strap portion 160 to the second strap portion 130 may be adjusted to maximize comfort of the wearer around the ears. The adjustments may be done by hand without removing the mask allowing for better and quicker adjustments to be made.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A facial protection device comprising:
a facial covering portion shaped to cover portion of a face of a person including the mouth of the person when the facial protection device is worn on a head of the person;
a first strap portion attached to the facial covering portion, the first strap portion having a first length;
a second strap portion attached to the facial covering portion, the second strap portion having a second length, wherein the first length and the second length are sufficient for the first strap portion and the second strap portion to connect around the head of the person when the facial protection device is worn on the head of the person;
a third strap portion attached to the facial covering portion, the third strap portion arranged to adjustably attach to the first strap portion via a first connector behind a first ear of the head of the person when the facial protection device is worn on the head of the person; and
a fourth strap portion attached to the facial covering portion, the fourth strap portion arranged to adjustably attach to the second strap portion via a second connector behind a second ear of the head of the person when the facial protection device is worn on the head of the person.

2. The facial protection device of claim 1, wherein the third strap portion is adjustably attached to the first strap portion such that under manual pressure the first connector moves on the first strap portion and during normal use of the facial protection device the first connector does not move on the first strap portion, and wherein the fourth strap portion is adjustably attached to the second strap portion such that under manual pressure the second connector moves on the second strap portion and during normal use of the facial protection device the second connector does not move on the second strap portion.

3. The facial protection device of claim 1, wherein a third connector is arranged to be behind the head of the person connecting the first strap portion and the second strap portion, when the facemask is worn on the head of the person.

4. The facial protection device of claim 3, wherein the first strap portion is adjustably attached to the second strap portion such that under manual pressure the third connector moves on the second strap portion and during normal use of the facial protection device the third connector does not move on the first strap portion.

5. The facial protection device of claim 1, wherein the facial covering portion includes
a first sleeve passing through the facial covering portion and a second sleeve passing through the facial covering portion,
wherein the first strap portion and second strap portion form a single first strap that passes through the first sleeve, and
the third strap portion and fourth strap portion form a single second strap that passes through the second sleeve.

6. The facial protection device of claim 1, wherein the facial covering portion further includes a pocket in the facial covering portion, and the pocket is configured to hold a removable filter.

7. A facial protection device comprising:
a facial covering portion including a fabric material;
a first strap portion attached to the facial covering portion, the first strap portion having a first length;
a second strap portion attached to the facial covering portion, the second strap portion having a second length;
a third strap portion attached to the facial covering portion, the third strap portion arranged to adjustably attach to the first strap portion via a first connector; and
a fourth strap portion attached to the facial covering portion, the fourth strap portion arranged to adjustably attach to the second strap portion via a second connector.

8. The facial protection device of claim 7, wherein the third strap portion is adjustably attached to the first strap portion such that the first connector moves on the first strap portion, and wherein the fourth strap portion is adjustably attached to the second strap portion such that the second connector moves on the second strap portion.

9. The facial protection device of claim 7, wherein a third connector adjustably connects the first strap portion and the second strap portion.

10. The facial protection device of claim 9, wherein the first strap portion is adjustably attached to the second strap portion such that the third connector moves on the second strap portion.

11. The facial protection device of claim 7, wherein the facial covering portion includes
a first sleeve passing through the facial covering portion and a second sleeve passing through the facial covering portion,
wherein the first strap portion and second strap portion form a single first strap that passes through the first sleeve, and
the third strap portion and fourth strap portion form a single second strap that passes through the second sleeve.

12. The facial protection device of claim 7, wherein the fabric material forms a pocket in the facial covering portion, and the pocket is configured to hold a removable filter.

13. A facial protection device comprising:
a facial covering portion including a fabric material which forms a first sleeve and a second sleeve;
a first strap passing through the first sleeve, wherein the first strap has a first length, wherein the first strap includes a first strap portion extending from a first side of the facial covering portion and a second strap portion extending from a second side opposite the first side of the facial covering, wherein the first strap portion is adjustably attached to the second strap portion;
a second strap passing through the second sleeve, wherein the second strap has a second length, wherein the second strap includes a third strap portion extending from the first side of the facial covering portion and a fourth strap portion extending from the second side of the facial covering, wherein the third strap portion is adjustably attached to the first strap portion, and wherein the fourth strap portion is adjustably attached to the second strap portion.

14. The facial protection device of claim 13, wherein the third strap portion is adjustably attached to the first strap portion via a first connector, and wherein the fourth strap portion is adjustably attached to the second strap portion via a second connector.

15. The facial protection device of claim 14, wherein the third strap portion is adjustably attached to the first strap portion such that the first connector moves on the first strap portion, and wherein the fourth strap portion is adjustably attached to the second strap portion such that the second connector moves on the second strap portion.

16. The facial protection device of claim 14, wherein a third connector adjustably connects the first strap portion and the second strap portion.

17. The facial protection device of claim 16, wherein the first strap portion is adjustably attached to the second strap portion such that the third connector moves on the second strap portion.

18. The facial protection device of claim 13, wherein the fabric material forms a pocket in the facial covering portion, and the pocket is configured to hold a removable filter.
